(19) United States
(12) Patent Application Publication
(10) Pub. No.: US 2017/0111256 A1
(43) Pub. Date: Apr. 20, 2017

(54) HIERARCHICAL QUERY RESPONSE LIMITER

(71) Applicant: ADTRAN, INC., Huntsville, AL (US)

(72) Inventor: Todd A. Neal, Harvest, AL (US)

(21) Appl. No.: 14/887,489

(22) Filed: Oct. 20, 2015

(51) Int. Cl. H04L 12/26

(52) U.S. Cl. CPC H04L 43/16; H04L 43/08

(57) ABSTRACT

Methods, systems, and apparatus for automatically truncating a hierarchical query response are disclosed. In one aspect, a query for hierarchically arranged data about a telecommunications device is received by the telecommunications device. Creation of a response that includes at least a portion of the requested hierarchically arranged data is initiated. Prior to completing the response, that a response constraint will be exceeded by a completed response is determined. In response to the determination, the response is truncated to include less than all of the requested hierarchically arranged data. Reference data indicating that the response has been truncated is inserted into the truncated response. The truncated response with the reference data is transmitted to a device that submitted the query.

### BACKGROUND

This specification relates to automatically truncating a hierarchical query response.

In a telecommunication network, network monitoring equipment may query line cards, etc. for hierarchical configuration information. The line cards can provide the hierarchical configuration information in response to the query. The resources and/or time required by the line cards to provide the response depend on the amount of configuration information being provided.

### SUMMARY

In general, one innovative aspect of the subject matter described in this specification can be embodied in methods for automatically truncating a hierarchical query response. Methods can include receiving, by a telecommunications device, a query for hierarchically arranged data about the telecommunications device; initiating creation of a response that includes at least a portion of the requested hierarchically arranged data; prior to completing the response, determining that a response constraint will be exceeded by a completed response; in response to the determination, truncating the response to include less than all of the requested hierarchically arranged data; inserting, into the truncated response, reference data indicating that the response has been truncated; and transmitting the truncated response with the reference data to a device that submitted the query (also referred to as a client device).

These and other embodiments can each optionally include one or more of the following features. The response constraint can include a memory constraint or a time constraint. The time constraint can include a real-time constraint or CPU time constraint for creating the response. The response can include a set of configuration data, a set of status data, or both for the telecommunications device. The truncated response can include a network location from which data truncated from the response is retrievable. The network location can be inserted in a hierarchical level of the data that was truncated from the response. Methods can further include receiving, by the telecommunications device, a second query including the network location that was included in the truncated response, and providing a second portion of the hierarchically arranged data that does not include the truncated response. An indication, instead of the network location, can be inserted into the truncated response to indicate that the response was truncated. The receiving, initiating, determining, truncating, inserting, and transmitting can each be performed by a telecommunications line card. The truncated response can be a syntactically valid response that is parsable by the client device. The telecommunications device does not need to keep state information regarding the requested hierarchically arranged data. This is advantageous because the client device can simply stop requesting data if it believes it has the information it needs, while also allowing the telecommunications device to serve many client devices without maintaining session information on a per-client-device basis.

Particular embodiments of the subject matter described in this specification can be implemented so as to realize one or more of the following advantages. Dynamically truncating query responses based on the actual amount of data to be returned or time consumed can enable a telecommunications device, with limited resources (e.g., CPU power, memory size, etc.), to respond to queries for hierarchically arranged data without rebooting or entering a failure state. This enables legacy equipment, which may have less processing capability and/or less memory than currently deployed equipment, to provide the same hierarchical response data as the currently deployed equipment. The truncated response can be produced in the same format as a full response, so that the requesting device can parse the truncated response in the same manner as a full response. The requesting device can parse the truncated response and, upon detecting that the response is a truncated response, may submit another query to retrieve the missing data from the telecommunications device. Unlike a simple truncate, and resuming upon the next request mechanism, the subject matter described in this specification does not require the telecommunications device to maintain knowledge of past requests. Therefore, resource consumption at the telecommunications device can be reduced. Further, memory constraint or time constraint can be dynamically calculated based upon memory usage or device load to allow the telecommunications device to respond to queries for hierarchically arranged data in a dynamic environment.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1A is a block diagram illustrating an example system for automatically truncating a hierarchical query response.

FIG. 1B is another block diagram illustrating another example system for automatically truncating a hierarchical query response.

FIG. 2 is a flow diagram of an example interaction between the components of the example system.

FIG. 3 is an example screenshot of a sample full response.

FIG. 4 is an example screenshot of a sample truncated response.

FIG. 5 is an example screenshot of a sample second response.

FIG. 6 is a flowchart of an example process for automatically truncating a hierarchical query response.

Like reference numbers and designations in the various drawings indicate like elements.

### DETAILED DESCRIPTION

The present disclosure describes methods, systems, and apparatus for automatically truncating a hierarchical query response provided by telecommunications equipment (e.g., line cards). This disclosure describes the process to generate a truncated query response for hierarchically arranged data (e.g., the data is organized into a tree-like structure) upon exceeding response constraints (e.g., memory constraint or time constraint). Although this disclosure has been described in terms of hierarchical data structure, the subject matter of this document can be applied to processing of other data structures (e.g., tabular data).

Queries for device configuration and/or status data that are modeled in a hierarchical or nested manner can result in large or time-consuming responses. When the response exceeds a time constraint (e.g., failure to service a watchdog) or the response data exceeds a memory constraint (e.g., memory exhaustion), a device responding to the queries may reboot or enter a failure state. There are several approaches to handling a query response that exceeds response constraints, including generating an alert, rebooting, entering a failure state, and others. This disclosure describes techniques for truncating the response, meaning that the full response is truncated (e.g., cut short) to meet the response constraints at the telecommunications device. In some implementations, the truncated response is formatted in a same manner as a full response so that the truncated response is still considered a valid response to the requesting device.

The disclosed subject matter addresses problems that arise due to the resource variation of the telecommunications devices (e.g., different CPU power, different memory size, etc.) when handling queries for large hierarchically arranged data. For example, some telecommunications devices will reboot or enter a fault state if the response to the query takes longer than a specified amount of time, requires more than a specified amount of memory, or requires more processing capabilities than are provided by the telecommunications devices. Using the techniques discussed in this document, reboots and/or fault states caused by these queries can be prevented. Any telecommunications devices with limited resources (e.g., limited memory or processing capabilities) can benefit from the subject matter described in this document.

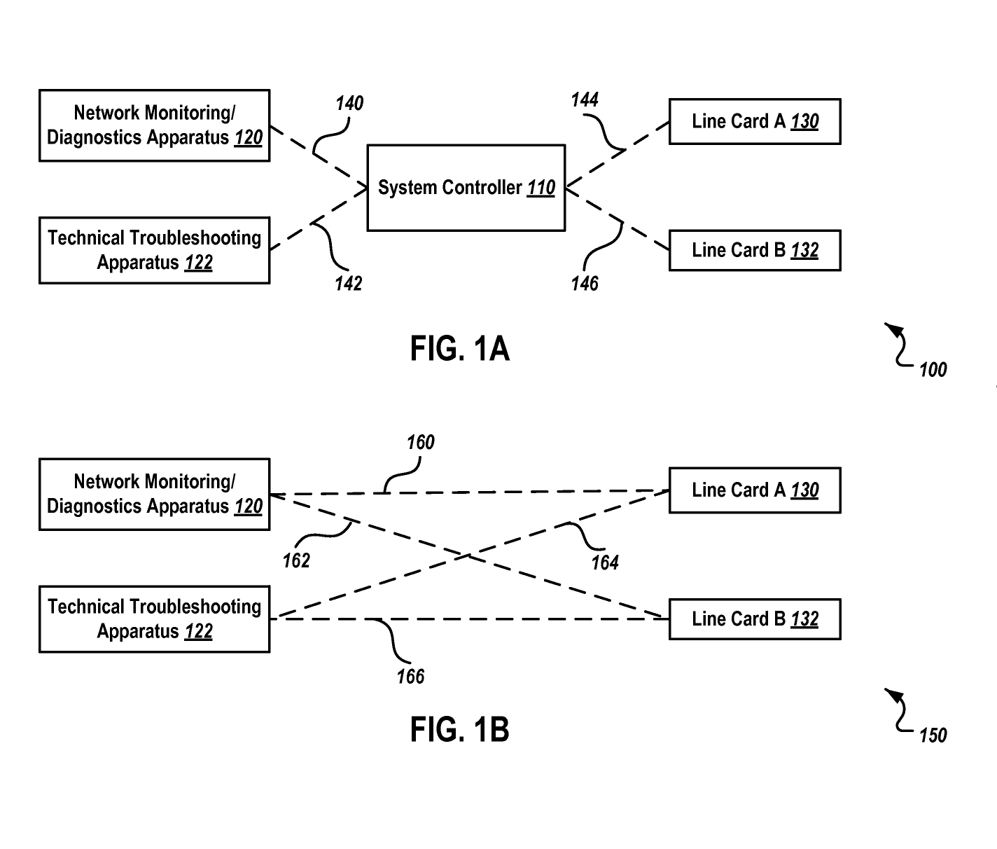

In some cases, requesting devices (e.g., network monitoring/diagnostics apparatus, technical troubleshooting apparatus, etc.) transmit, receive, and process query/response messages for hierarchically arranged device configuration and/or status data. For example, as discussed with reference to FIG. 1, a requesting device can transmit a query to a telecommunications device (e.g., line card) through a System Controller Module (SCM) when the telecommunications device cannot be individually addressed (e.g., the telecommunications device does not have an IP address). In some cases, as discussed with reference to FIG. 1B, the requesting device can transmit a query to the telecommunications device directly when the telecommunications device can be individually addressed (e.g., the telecommunications device has an IP address). When a response is received from the telecommunications device (either directly or through the SCM), the requesting device can process the response to determine whether the response is a full response or a truncated response. In response to the determination that the response is a truncated response, the requesting device can parse the truncated response and may submit an additional query to retrieve the missing date if the truncated response does not contain the information the requesting device is seeking.

In some cases, telecommunications devices receive, process, and transmit query/response messages for hierarchically arranged device configuration and/or status data about the telecommunications devices. For example, as discussed with reference to FIGS. 1A and 1B, a telecommunications device can receive a query from a requesting device through an SCM or directly (e.g., without going through an SCM).

During the data retrieval and serialization process, the telecommunications device can monitor the process to make sure that the generated response does not exceed response constraints on the telecommunications device. In some cases, the telecommunications device can calculate an elapsed time (e.g., real time, CPU time, etc.) of the response formation and/or an amount of consumed space (e.g., memory usage) at certain termination points within the process where it can safely terminate data retrieval and serialization. The termination points are chosen such that a sentinel value can be inserted in the data response. The sentinel value indicates that some data is missing from the response.

If the termination points are chosen such that they occur uniformly throughout the data set, then it can be truncated at nearly any point allowing truncation of the returned data at points very close to the desired size or time limits. In some cases, the sentinel value has no other meaning within the data set context. In some cases, the sentinel value can include a unique value that provides additional information to help the requesting device construct another query to retrieve the missing data. The unique value can be a network location from which data truncated from the response is retrievable. The network location can be inserted in a hierarchical level of the data that was truncated from the response.

By inserting the sentinel value in the truncated response, the telecommunications device is not required to maintain or track state information regarding the requested hierarchically arranged data. In some cases, the sentinel value can be accompanied by out of band data (e.g., a unique HTTP response code) to inform the requesting device that the full response was not returned. Although the out of band data is not required (as the presence of a sentinel value conveys the same information), it may be desirable to some users for quick determination of missing data.

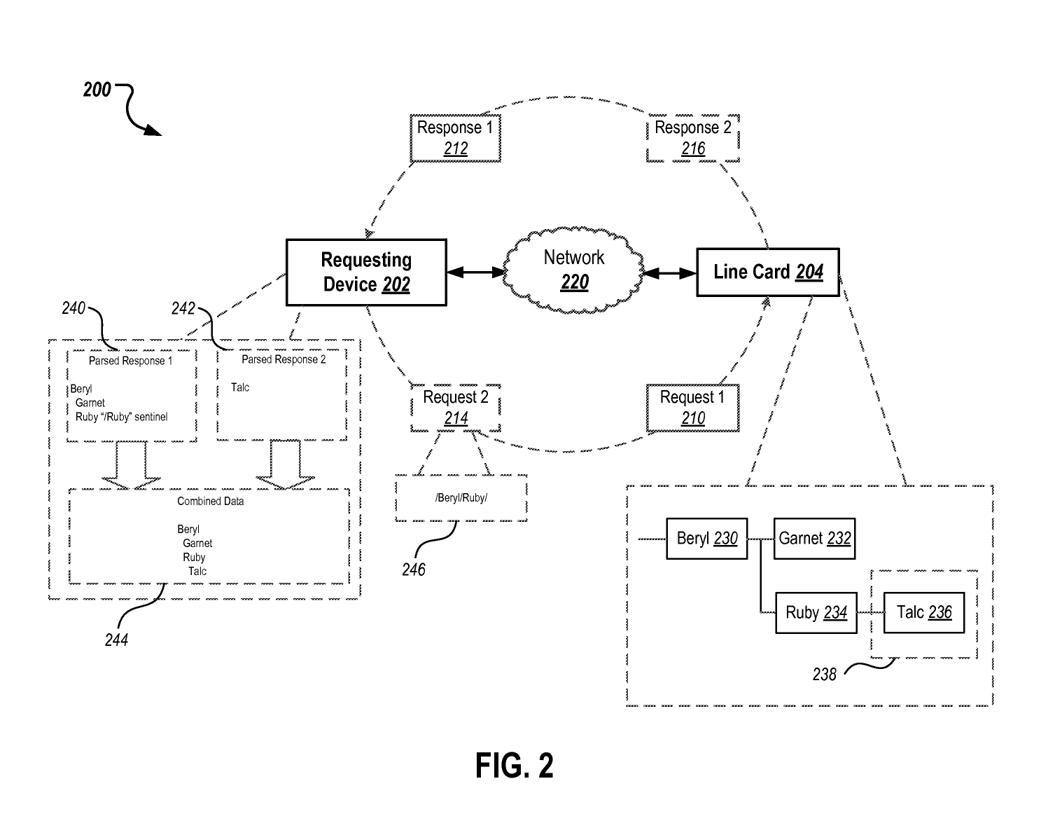

As discussed in more detail with respect to FIGS. 2-5, in some cases, two queries and two responses are required to generate a full response for the requesting device. For example, a requesting device submits a first query to a telecommunications device. Before generating a full response for the first query, the telecommunications device may determine that a response constraint is met. In response to determining that the response constraint is met, the telecommunications device can terminate the data retrieval and serialization process, truncate the response to include currently available data (e.g., data already obtained and/or included in the response), insert a sentinel value to indicate truncation, and transmit the truncated response (first response) to the requesting device.

The requesting device receives the first response, parses the first response, and identifies the sentinel value in the response. In response to identifying the sentinel value, the requesting device then issues, to the telecommunications device, a subsequent query (second query) indicating the missing data according to the sentinel value. Upon receiving the second query, the telecommunications device can retrieve only the requested missing data and provide, in a second response to the requesting device, the data that was truncated from the first response (or a portion thereof if the response constraint is met during formation of the second response). The requesting device, then, can combine data in the first and second responses to generate the full response.

Turning to the illustrated embodiment, FIG. 1A is a block diagram illustrating an example system 100 for automatically truncating a hierarchical query response. The example system 100 includes a system controller 110 that communicates with a network monitoring/diagnostics apparatus 120 (e.g., a requesting device) over a communication link 140, with a technical troubleshooting apparatus 122 (e.g., a requesting device) over a communication link 142, with line card A 130 (e.g., a telecommunications device) over a communication link 144, and with line card B 132 (e.g., a telecommunications device) over a communication link 146. The communication links 140, 142, 142, and 146 can wireline or wireless links. In some cases, the communication links can be part of a telecommunications network as discussed in more detail below with respect to FIG. 2.

As illustrated, the example system 100 includes a system controller 110. The system controller 110 includes any application, hardware, software, firmware, or combination thereof configured to communicate with each individual line card. The system controller 110 generally forwards queries from the network monitoring/diagnostics apparatus 120 and the technical troubleshooting apparatus 122 to the corresponding line card, and forwards responses from the line card A 130 and the line card B 132 back to the corresponding apparatus. In some cases, the system controller 110 can communicate with the line cards and query the line cards for hierarchically arranged data about the line cards.

The system controller 110 can be configured to identify, within a first query response from a given line card, reference data indicating that the response has been truncated. The system controller 110 can be configured to transmit, based on the reference data, a follow-up request for a portion of the hierarchically arranged data that was not included in the first query response. The system controller 110 can combine data from the first query response and a second query response to the follow-up request to obtain a complete response. The system controller 110 can be configured to present, at a display device, the combined data as hierarchically arranged data about the line card.

The example system 100 includes a network monitoring/diagnostics apparatus 120 and a technical troubleshooting apparatus 122. The network monitoring/diagnostics apparatus 120 and a technical troubleshooting apparatus 122 are examples of requesting devices that can request hierarchical configuration data from telecommunications devices. Although two apparatuses are illustrated in FIG. 1A, a different number of apparatuses may be used according to particular needs, desires, or particular implementations of system 100. Network monitoring/diagnostics apparatus 120 and technical troubleshooting apparatus 122 include any application, hardware, software, firmware, or combination thereof configured to transmit a query to and receive a response from the line cards. In some cases, the network monitoring/diagnostics apparatus 120 and the technical troubleshooting apparatus 122 can send a query for hierarchically arranged data to the system controller 110 and receive a query response from the system controller 110 without knowing which line card is handling the query and the response.

The example system 100 includes line card A 130 and line card B 132. Although two line cards are illustrated in FIG. 1A, a different number of line cards may be used according to particular needs, desires, or particular implementations of system 100. Line card A 130 and line card B 132 are telecommunications devices that are connected between a central office (or data center) and customer premises equipment (CPEs) to connect the CPEs to an access network. Multiple line cards can be installed in a same Multi-service Access Node (MSAN), and the line cards in a given MSAN can provide various levels/types of network access to CPEs serviced by the MSAN. For example, the various line cards may provide T1 service, xDSL service, Gigabit Passive Optical Network (GPON) service, or 10 Gigabit Ethernet service to various CPEs. The line cards aggregate communications from the various CPEs and provide access to an IP Core network.

The line card A 130 and the line card B 132 each include transceivers that are configured to transmit and receive data over a telecommunications network. The line card A 130 and the line card B 132 can also include a data processor that responds to queries for hierarchically arranged data about the line card. The data processor can be configured to execute instructions and manipulate data to perform the operations described with reference to the line card A 130 and the line card B 132.

The line card (e.g., line card A 130 or line card B 132) is configured to initiate creation of a response that includes at least a portion of the requested hierarchically arranged data in response to receiving a query for the hierarchically arranged data about the line card. The line card then determines that a response constraint will be exceeded by a completed response prior to completing the response. In response to the determination, the line card truncates the response to include less than all of the requested hierarchically arranged data and insert, into the truncated response, reference data indicating that the response has been truncated. The line card transmits the truncated response with the reference data to the network monitoring/diagnostics apparatus 120 and/or the technical troubleshooting apparatus 122.

In some cases, the line card A 130 and the line card B 132 connect to the same set of subscribers. If the line card A 130 and the line card B 132 have different local resources (e.g., CPU power, memory size, etc.), the line card A 130 and the line card B 132 can generate different responses to the same query. For example, the line card A 130 with a more powerful CPU and/or a larger memory than line card B 132 can provide a full response while the line card B 132 with a weaker CPU and/or a smaller memory than line card 130 may provide a truncated response.

FIG. 1B is another block diagram illustrating another example system 150 for automatically truncating a hierarchical query response. The example system 150 includes a network monitoring/diagnostics apparatus 120 and a technical troubleshooting apparatus 122 that directly communicate with line card A 130 and line card B 132 over communication links 160, 162, 164, and 166. In this example system 150, the network monitoring/diagnostics apparatus 120 and the technical troubleshooting apparatus 122 can query a specific line card (e.g., line card A 130 or line card B 132) for hierarchically arranged data of the specific line card. For example, if the specific line card has an IP address, the network monitoring/diagnostics apparatus 120 and the technical troubleshooting apparatus 122 can query the specific line card directly by using the IP address of the specific line card. Other components and functionalities are similar to those discussed above with reference to FIG. 1A.

FIG. 2 is a flow diagram of an example interaction 200 between the components of the example system 100/150 to generate a query response for a hierarchical data set. In some implementations, the interaction 200 may include additional and/or different components not shown in the flow diagram. Components may also be omitted from the interaction 200, and additional messages may be added to the interaction 200.

As illustrated in FIG. 2, the requesting device 202 (e.g., the network monitoring/diagnostics apparatus 120 or the technical troubleshooting apparatus 122 as discussed in FIGS. 1A and 1B) is connected to line card 204 (e.g., the line card A 130 or the line card B 132 as discussed in FIGS. 1A and 1B) through a network 220. The line card 204 connects to a set of devices (e.g., user devices) arranged in a hierarchical manner. The root/first level device Beryl 230 is connected to the line card 204 directly. There are two second level devices Garnet 232 and Ruby 234 (e.g., subsystems of Beryl 230) that are connected to the root/first level device Beryl 230. The third level device Talc 236 (e.g., subsystem of Ruby 234) is connected to the second level device Ruby 234.

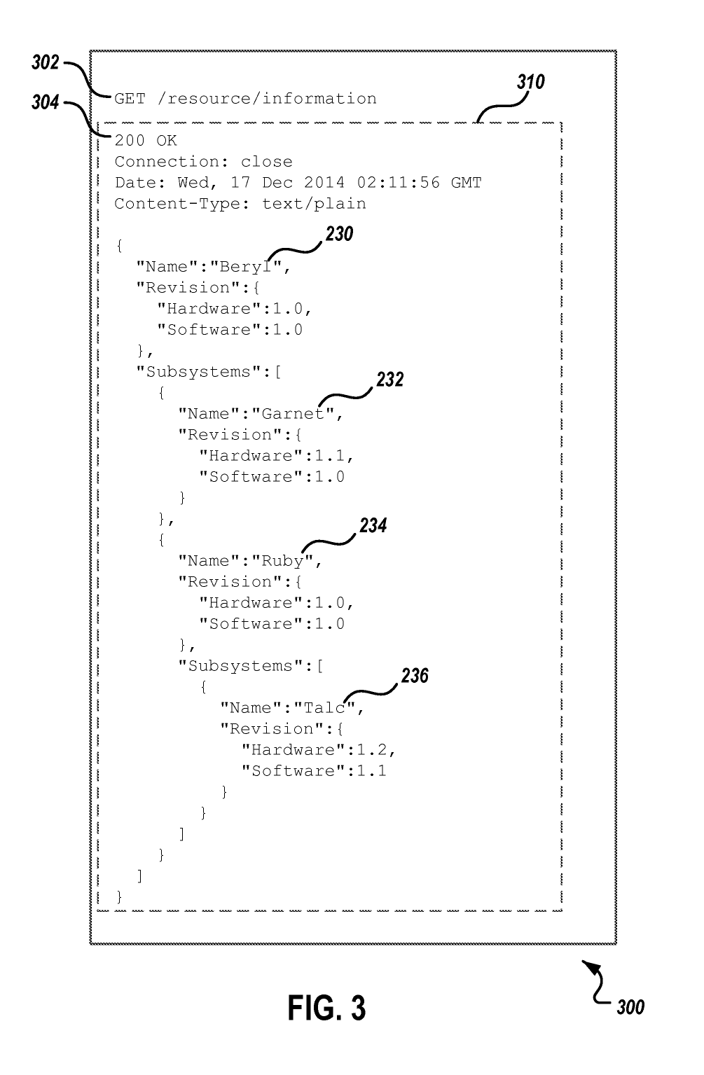

The requesting device 202 transmits a query message over the network 220 to the line card 204 for device configuration and/or status data of the hierarchically arranged devices (e.g., Beryl 230, Garnet 232, Ruby 234, and Talc 236). In response to receiving the query message, the line card 204 generates a response message and transmits the response message over the network 220 to the requesting device 202. In some cases, a response constraint is met at the line card 204 before it generates a full response for the query message. Due to the response constraint, the line card 204 truncates the response to include currently available data, inserts a sentinel value to indicate truncation, and transmits the truncated response to the requesting device 202. The requesting device 202 may submit a subsequent query message for the missing data if the truncated response does not contain the information the requesting device 202 is seeking. The queries and responses between the requesting device 202 and the line card 204 will be discussed in more detail below with respect to FIGS. 3-5.

The network 220 facilitates wireless or wireline communications between the components of the interaction 200 (e.g., between requesting device 202 and line card 204, and among others), as well as with any other local or remote computer, such as additional requesting devices, servers, or other devices communicably coupled to the network 220, including those not illustrated in FIG. 2. As illustrated in FIG. 2, the network 220 is depicted as a single network, but may be comprised of more than one network without departing from the scope of this disclosure, so long as at least a portion of the network 220 may facilitate communications between senders and recipients.

In some cases, one or more of the illustrated components may be included within network 220 as one or more cloud-based services or operations. The network 220 may be all or a portion of an enterprise or secured network, while in another case, at least a portion of the network 220 may represent a connection to the Internet. In some cases, a portion of the network 220 may be a virtual private network (VPN). Further, all or a portion of the network 220 can comprise either a wireline or wireless link. Example wireless links may include 802.11ac/ad/af/a/b/g/n, 802.20, WiMax, LTE, and/or any other appropriate wireless link. In other words, the network 220 encompasses any internal or external network, networks, sub-network, or combination thereof operable to facilitate communications between various computing components inside and outside the illustrated interaction 200. The network 220 may communicate, for example, Internet Protocol (IP) packets, Frame Relay frames, Asynchronous Transfer Mode (ATM) cells, voice, video, data, and other suitable information between network addresses. The network 220 may also include one or more local area networks (LANs), radio access networks (RANs), metropolitan area networks (MANs), wide area networks (WANs), all or a portion of the Internet, and/or any other communication system or systems at one or more locations.

As illustrated, the requesting device 202 sends a first query (e.g., request 1 210) to the line card 204 through the network 220. The first query includes a request for the whole hierarchically arranged subscriber configuration information and/or status data of the line card 204. As illustrated in FIG. 2, the subscribers include Beryl 230, Garnet 232, Ruby 234, and Talc 236. The configuration and/or status data may include a name, a hardware revision, and/or a software revision of the subscriber. In some cases, a system controller 110 can forward the first query from the requesting device 202 to the line card 204.

In response to the first query, the line card 204 transmits a first response (e.g., response 1 212) to the requesting device 202 through the network 220. For purposes of example, assume that due to a memory constraint or a time constraint, the line card 204 cannot retrieve and serialize all the requested data without violating a response constraint. For example, assume that the line card 204 is unable to retrieve and serialize the configuration and/or status data of subscriber Talc 236, which is referred to as missing data 238. In this example, the line card 204 terminates the data retrieval and serialization process upon determining that the memory constraint or the time constraint have been met, and truncates the full response to include only the available data (e.g., the configuration and/or status data of subscribers Beryl 230, Garnet 232, and Ruby 234). The line card 204 also inserts a sentinel value right after the data of Ruby 234 to indicate the truncation, and then transmits the truncated response (e.g., response 1 212) to the requesting device 202.

Upon receiving the first response, the requesting device 202 parses the first response and determines that the first response is not a full response by at least identifying the sentinel value in the first response. In this interaction 200, the requesting device 202 does not receive all of the requested information in the first response, and therefore constructs a second query (e.g., request 2 214) for the missing data after Ruby 234 based on the parsed first response 240 and/or the sentinel value. The requesting device 202 transmits the second query to the line card 204 through the network 220 to obtain more of the requested information. The second query is formatted to include an indication of a location of the missing data 246 (e.g., “/Beryl/Ruby/”).

Upon receiving the second query, the line card 204 identifies that the second query provides only part of the hierarchical data, not the whole set of hierarchical data. The line card 204 then queries a specific device identified from the second query for the information needed. For example, the line card 204 utilizes the location information “/Beryl/Ruby/” from the second query and identifies that the second query is for Talc 236, the subsystem of Ruby 234. As a result, the line card 204 queries the device Talc 236, instead of the root level device Beryl 230, and only retrieves the missing data 238. Once the missing data 238 is acquired, the line card 204 generates a second response (e.g., response 2 216) including the missing data 238 and transmits the second response to the requesting device 202 through the network 220.

Upon receiving the second response, the requesting device 202 parses the second response, acquires the missing data 238 from the parsed second response 242, and combines the missing data 238 with the data acquired from the parsed first response 240 to produce the full hierarchically arranged configuration and/or status data 244 of the line card 204.

FIG. 3 is an example screenshot 300 of a sample full response. As illustrated in screenshot 300, a sample request response session is shown with HTTP requests and “JavaScript Object Notation” (JSON) responses. The requesting device 202 submits a query 302 (e.g., “GET/resource/information”) to line card 204 as discussed in FIG. 2 and receives a full response 310. The full response 310 includes a status indicator 304 (e.g., “200 OK”), root/first level data 230 (e.g., device Beryl), second level data 232 and 234 (e.g., device Garnet and device Ruby), and third level data 236 (e.g., device Talc) of the hierarchically arranged device configuration and/or status data about the line card 204. At the beginning of the full response 310, the status indicator 304 is presented to indicate that a full response is provided. In the sample request response session, the response 310 is generated without violating any memory constraint and/or time constraint at line card 204.

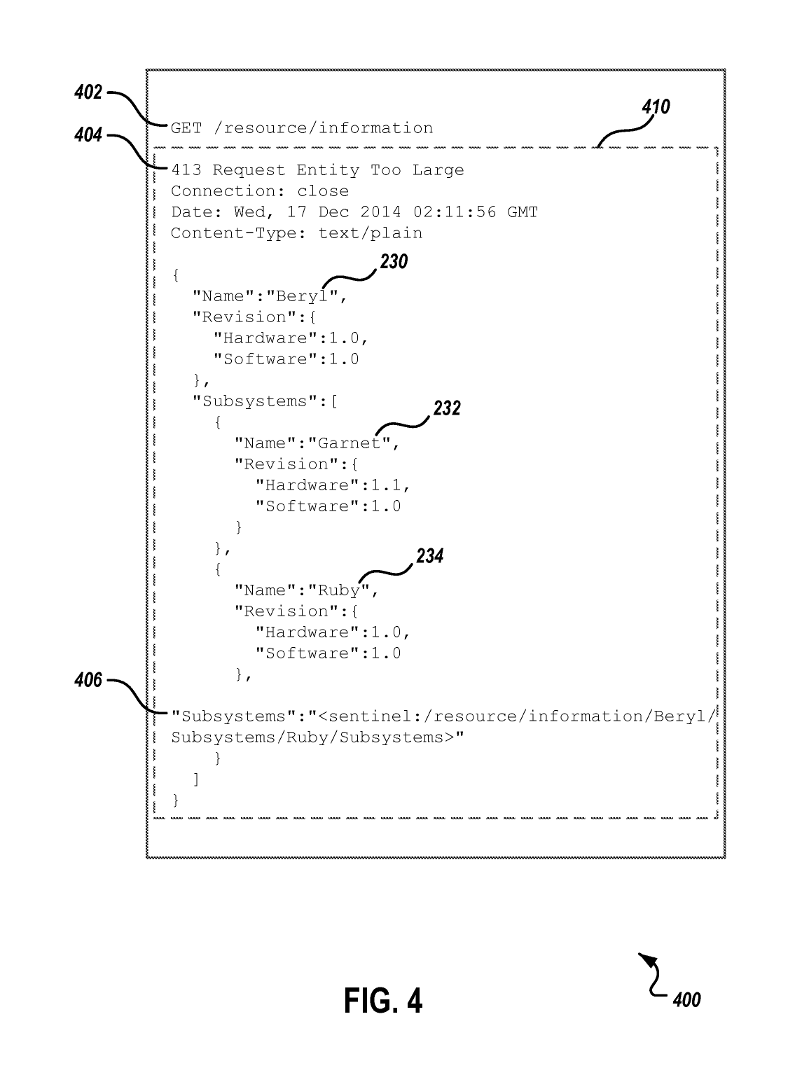

FIG. 4 is an example screenshot 400 of a sample truncated response. As illustrated in screenshot 400, a sample request response session is shown with HTTP requests and JSON responses. The line card 204 receives a first query 402 (e.g., “GET/resource/information”) from the requesting device 202 as discussed in FIG. 2 and generates a truncated response (first response) 410 with an out of band data 404 and a sentinel value 406 inserted.

The truncated response 410 includes the out of band data 404 (e.g., an HTTP 413 response “413 Request Entity Too Large”), root/first level data 230 (e.g., device Beryl), second level data 232 and 234 (e.g., device Garnet and device Ruby) of the hierarchically arranged device configuration and/or status data about the line card 204, and a sentinel value 406 indicating that the response 410 has been truncated. At the beginning of the truncated response 410, the out of band data 404 is presented to inform the requesting device 202 that a full response was not returned. Although the out of band data 404 is optional, it can be desirable for a quick determination of response status. The third level data 236 (e.g., device Talc) is missing from the truncated response 410 due to a violation of a memory constraint as indicated in the out of band data 404.

Upon receiving the first query, the line card 204 identifies that the first query is for the whole hierarchical data. The line card 204 then queries the root device (e.g., device Beryl 230) for the information needed. In this request response session, the line card 204 terminates JSON arrays and objects upon determining the violation of the memory constraint. The line card 204 truncates the response data to leave out the incomplete third level data 236, insert the out of band data 404 at the beginning of the truncated response, and inserts the sentinel value 406 to generate the truncated response 410 for the first query 402. The sentinel value 406 is inserted in the truncated response 410 at a location where the missing third level data 236 should be located. In this sample request response session, the sentinel value 406 includes the network location “/resource/information/Beryl/Subsystems/Ruby/Subsystems” from which the missing third level data 236 is retrievable. The network location indicates that response data has been truncated, the truncation is done after data of Ruby 234, and the missing data is for subsystems of Ruby 234. In some implementations, inclusion of the network location is optional since the requesting device 202 can deduce the network location from the location of the sentinel value 406 in the truncated response 410. Once the truncated response is generated, the line card 204 transmits the truncated response to the requesting device 202.

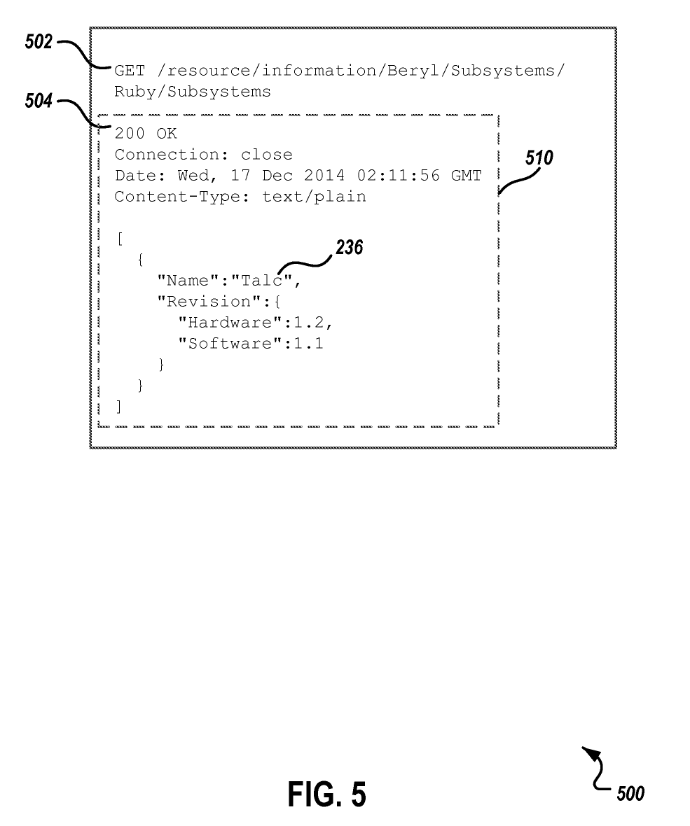

FIG. 5 is an example screenshot 500 of a sample second response. As illustrated in screenshot 500, a sample request response session is shown with HTTP requests and JSON responses. The line card 204 receives a second query 502 for the missing third level data 236 (e.g., “GET/resource/information/Beryl/Subsystems/Ruby/Subsystems”) from the requesting device 202 in a manner similar to that discussed above with reference to FIG. 4 and generates a second response 510 only for the missing third level data 236.

The second response 510 includes a status indicator 504 (e.g., “200 OK”), and the missing third level data 236 (e.g., device Talc) of the hierarchically arranged device configuration and/or status data about the line card 204. At the beginning of the second response 510, the status indicator 504 is presented to indicate that a full response is provided because the end of the hierarchical data (e.g., data 236) has been reached.

In this sample request response session, the line card 204 generates the second response 510 without violating any memory constraint and/or time constraint. Upon receiving the second query, the line card 204 identifies that the second query is for part of the hierarchical data, not the whole set of hierarchical data. The line card 204 then queries a specific device identified from the second query for the information needed. For example, the line card 204 utilizes the location information “/resource/information/Beryl/Subsystems/Ruby/Subsystems” from the second query and identifies that the second query is for Talc 236, the subsystem of Ruby 234. As a result, the line card 204 queries the device Talc 236, instead of the root level device Beryl 230, and only retrieves data about Talc 236 and its subsystems. Once the data about Talc 236 and its subsystems is acquired, the line card 204 generates a second response (e.g., response 2 216) including the status indicator 504 at the beginning of the response and the missing data 238, and transmits the second response to the requesting device 202 through the network 220.

Upon receiving the second response 510, the requesting device 202, then, can combine the root/first level data 230, the second level data 232 and 234 from the first response 410, and the third level data 236 from the second response 510 to generate a full response equivalent to the full response 310 as described in FIG. 3. In some cases, the second query 502 and the second response 510 are optional if the requesting device 202 is not interested in the third level data 236.

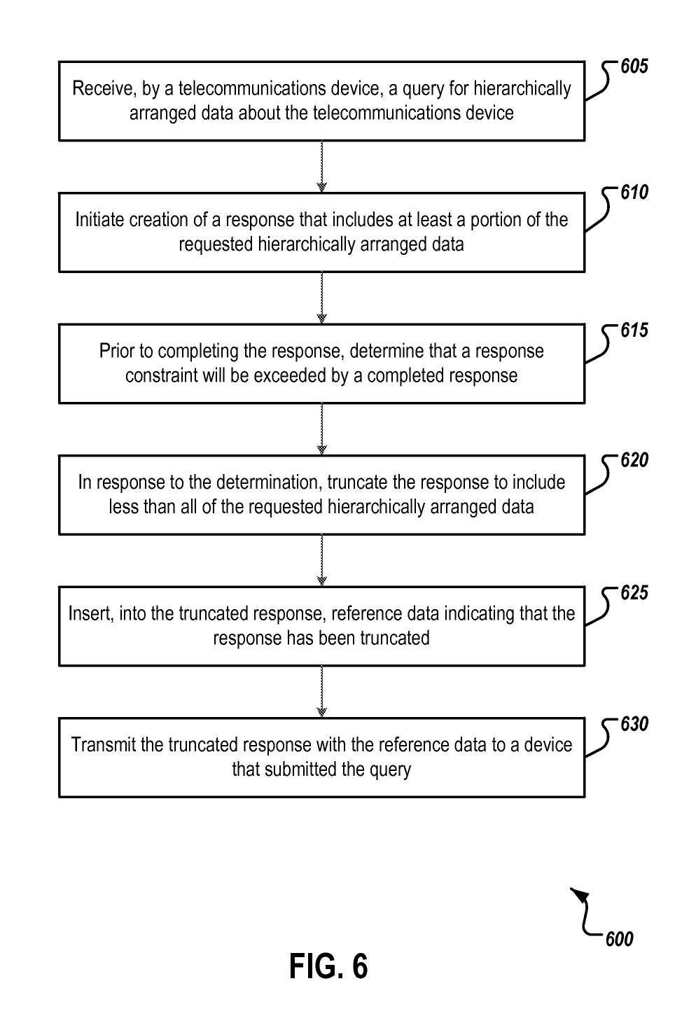

FIG. 6 is a flowchart of an example process 600 for automatically truncating a hierarchical query response. The example process 600 can be performed, for example, by one or more telecommunications devices such as those described with reference to FIGS. 1A, 1B, and 2. The example process 600 can also be implemented as instructions stored on a non-transitory, computer-readable medium that, when executed by one or more telecommunications devices, configures the one or more telecommunications devices to perform and/or cause the one or more telecommunications devices to perform the operations of the example process 600.

A query for hierarchically arranged data about a telecommunications device is received by the telecommunications device (605). In some cases, the query is for a set of configuration data about the telecommunications device. In some cases, the query is for a set of status data about the telecommunications device.

Creation of a response that includes at least a portion of the requested hierarchically arranged data is initiated (610). In some cases, the creation of the response is initiated immediately upon receiving the query. In some cases, the query is queued first and the creation of the response is initiated after the query is moved out of the queue for processing.

Prior to completing the response, that a response constraint will be exceeded by a completed response is determined (615). In some cases, the determination is based on the response time exceeding a real time limit for the response. In some cases, the determination is based on the response time exceeding a CPU time limit for the response. In some cases, the determination is based on the response data size exceeding a memory size limit for the response.

In response to the determination, the response is truncated to include less than all of the requested hierarchically arranged data (620). Reference data (e.g., sentinel value) indicating that the response has been truncated is inserted into the truncated response (625). In some cases, the reference data can include a network location from which data truncated from the response is retrievable. In some cases, the network location can be inserted in the hierarchical level of the data that was truncated from the response. The truncated response with the reference data is transmitted to a requesting device (630). In some case, the truncated response can include out of band data (e.g., a unique HTTP response code) to indicate truncation of the response in addition to the inserted sentinel value.

Additional process actions (not shown in FIG. 6) may be added to the example process 600. For example, after 630, a second query including the network location is received by the telecommunications device. A second portion of the hierarchically arranged data, which does not include the previous truncated response, is provided to the requesting device in response to receiving the second query.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination or in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method, comprising:
receiving, by a telecommunications device, a query for hierarchically arranged data about the telecommunications device;
initiating creation of a response that includes at least a portion of the requested hierarchically arranged data;
prior to completing the response, determining that a response constraint will be exceeded by a completed response;
in response to the determination:
truncating the response to include less than all of the requested hierarchically arranged data;
inserting, into the truncated response, reference data indicating that the response has been truncated; and
transmitting the truncated response with the reference data to a device that submitted the query.

2. The method of claim 1, wherein the response constraint includes a memory constraint or a time constraint.

3. The method of claim 2, wherein the time constraint includes real-time constraint or CPU time constraint for creating the response.

4. The method of claim 1, wherein initiating creation of a response that includes at least a portion of the requested hierarchically arranged data comprises including, in the response, a set of configuration data for the telecommunications device.

5. The method of claim 1, wherein initiating creation of a response that includes at least a portion of the requested hierarchically arranged data comprises including, in the response, a set of status data for the telecommunications device.

6. The method of claim 1, wherein inserting, into the truncated response, reference data indicating that the response has been truncated comprises inserting, into the truncated response, a network location from which data truncated from the response is retrievable.

7. The method of claim 6, wherein inserting a network location from which data truncated from the response is retrievable comprises inserting the network location in a hierarchical level of the data that was truncated from the response.

8. The method of claim 6, further comprising:
receiving, by the telecommunications device, a second query including the network location that was included in the truncated response; and
providing a second portion of the hierarchically arranged data, wherein the second portion does not include the truncated response.

9. The method of claim 1, wherein inserting, into the truncated response, an indication that the response was truncated, but not including a network location from which data truncated from the response is retrievable.

10. The method of claim 1, wherein the receiving, initiating, determining, truncating, inserting, and transmitting are each performed by a telecommunications line card.

11. The method of claim 1, wherein the truncated response is a syntactically valid response that is parsable by the device that submitted the query.

12. The method of claim 1, wherein the telecommunications device keeps no state information regarding the requested hierarchically arranged data.

13. A telecommunications device comprising:
a transceiver that transmits and receives data over a telecommunications network; and
a data processor that responds to queries for hierarchically arranged data about the telecommunications device, wherein, in response to receiving a query for the hierarchically arranged data about the telecommunications device, the data processor is configured to:
initiate creation of a response that includes at least a portion of the requested hierarchically arranged data;
prior to completing the response, determine that a response constraint will be exceeded by a completed response;
truncate the response to include less than all of the requested hierarchically arranged data;
insert, into the truncated response, reference data indicating that the response has been truncated; and
transmit the truncated response with the reference data to a device that submitted the query.

14. The device of claim 13, wherein the response constraint includes a memory constraint or a time constraint.

15. The device of claim 14, wherein the time constraint includes real-time constraint or CPU time constraint for creating the response.

16. The device of claim 13, wherein initiating creation of a response that includes at least a portion of the requested hierarchically arranged data comprises including, in the response, a set of configuration data for the telecommunications device.

17. The device of claim 13, wherein initiating creation of a response that includes at least a portion of the requested hierarchically arranged data comprises including, in the response, a set of status data for the telecommunications device.

18. The device of claim 13, wherein inserting, into the truncated response, reference data indicating that the response has been truncated comprises inserting, into the truncated response, a network location from which data truncated from the response is retrievable.

19. The device of claim 18, wherein the data processor is further configured to:
receive, by the telecommunications device, a second query including the network location that was included in the truncated response; and
provide a second portion of the hierarchically arranged data, wherein the second portion does not include the truncated response.

20. A telecommunications system, comprising:
a plurality of telecommunications nodes that transmit and receive data over a telecommunications network; and
a management device that communicates with the telecommunications nodes and queries the telecommunications nodes for hierarchically arranged data about the telecommunications nodes, wherein the management device is configured to:
identify, within a first query response from a given telecommunications node, reference data indicating that the response has been truncated;
transmit, based on the reference data, a follow-up request for a portion of the hierarchically arranged data that was not included in the first query response;
combine data from the first query response and a second query response to the follow-up request; and
present, at a display device, the combined data as hierarchically arranged data about the telecommunications device.
